(19) United States
(12) Patent Application Publication
(10) Pub. No.: US 2017/0363502 A1
(43) Pub. Date: Dec. 21, 2017

(54) Method and Device to Detect Fluid Leakage in a Joint Between Two Pipe Sections

(71) Applicant: ODIN CONNECT AS, Bergen (NO)

(72) Inventor: Rune Langhelle, Bergen (NO)

(21) Appl. No.: 15/538,350

(22) PCT Filed: Dec. 31, 2015
(86) PCT No.: PCT/NO2015/000031

§ 371 Date: Jun. 21, 2017

(30) Foreign Application Priority Data
Jan. 2, 2015 (NO) 20150004

(51) Int. Cl. G01M 3/28

(52) U.S. Cl. CPC G01M 3/2861

(57) ABSTRACT

A method is described to detect a fluid leakage in a joint area between two pipe sections (10, 12) that are joined together to provide a continuous fluid-carrying pipeline, where a casing-formed joint element (20) with an inwardly protruding flange part (28) is inserted between the pipe sections (10, 12), the ends of which lie against sealing elements (27a, 27b) at the oppositely directed flange surfaces, and a coupling body (60, 62) on each side of the joint element (20) forms an engagement with respective pipe circumference surfaces (17, 19) and is made to squeeze the pipe ends against each other via the joint element (20). The method is characterised in that a second sealing element (31a, 31b) that seals between the joint element (20), and the pipe section surfaces (17, 19) is set up at the pipe ends, and any fluid leakages past the two sealing systems (27, 31) are monitored in a fluid channel system (30, 32), in connection to the joint element (20), between the sealing systems (27, 31) and which is set up by a radially formed ring-formed hollow space (32a, 32b), outside respective sealing elements (27a, 27b) and defined between respective, oppositely directed flange surfaces (28) and the ends of the pipe sections (10, 12) where the hollow space is fluid connected with another channel system (30) via the joint element and connected to a pressure sensor (P, 52) that registers the pressure in the fluid channel system for alarms and the initiation of relevant actions. A device to carry out the method is also described.

The present invention relates to a method to detect fluid leakage in a joint area between two pipe sections that are joined together to provide a continuous fluid-carrying pipeline, where a casing-formed joint element with an inwardly protruding ring formed flange part is inserted between the pipe sections, the ends of which lie against sealing elements on the oppositely directed flange surfaces, and a coupling body on each side of the joint element forms an engagement in respective pipe circumference surfaces and is made to squeeze the pipe ends against each other via the joint element as can be seen in the introduction of the subsequent claim 1.

The invention also relates to a device as given in the introduction of the subsequent claim 10 that can be used to carry out the method.

In the following, the invention shall be described with reference to leakage testing of the joint between two pipes that are joined together end to end to make sure that the joint is completely leakproof without the occurrence of any leaks, and where the pipe ends are initially untreated. Such tests are carried out as pressure tests i.e. that the pipe is internally set under pressure after the ends have been joined together.

The invention is particularly suited to be used with pipes that are mechanically joined together with the help of joint pieces with oppositely directed flanges, or with in-between lying sealing material, and are screwed together with through-running axially directed bolts or other methods through the radially directed flanges, so that the joint between the pipe ends becomes completely leakproof. Furthermore, the construction is joined together in that a mutually adapted wedge-formed pair of collars which are inserted at the back and when screwed together squeeze knobs or sharp grooves down into the surface of the pipe end.

Such pressure testing is normally carried out in that the inside of the pipe is put under pressure by a fluid or medium such as a gas or liquid.

### PRIOR ART

Today pipe leak testing and pressure testing are carried out by pressurising the inside of the pipes after they have been joined together. The pipes can be joined together with the help of welding or other non-welded solutions such as the use of joint pieces with flanges.

The method relates to the use of a metal or rubber gasket (or another material) that is held in place on the pipe with a short neck on each side. (Seal carrier).

Then, one ensures that the gasket lies correctly when one forces the pipes together via flanges that are tightened, either weld flanges or other flanges. “Seal carrier” gaskets are available today.

With regard to prior art, reference is made to the International patent application WO-03/027561 that concerns a method for pressure testing the joint area between two oppositely facing flanges in a pipeline system. Hence, this does not relate to the joining of two “clean” pipes with untreated pipe ends, as in the present invention. An essential difference is that the present invention relates to a seal system against the outer surface of a pipe, something which is not relevant to what is suggested in the WO-patent.

### THE PRESENT INVENTION

The method according to the invention is characterised in that a second sealing element is arranged that seals between the joint element and the surfaces of the pipe section at the pipe ends, and any fluid leakages past the two seal systems are monitored in, or in connection to, the joint element, between the fluid channel system set up by the seal systems that are made up by, outside respective sealing elements, a radially formed ring-formed hollow space defined between respective, oppositely directed flange surfaces and the ends of the pipe sections where the hollow space is fluid connected with another channel system via the joint element and connected to a pressure sensor that registers the pressure in the fluid channel system to send out an alarm and the carrying out of any relevant action. Any action can be that one shuts off the fluid flow to repair and seal the leak.

The preferred embodiments are described in the claims 2-9.

The device according to the invention is characterised in that a second sealing element is arranged that seals between the joint element and the surfaces of the pipe section at the pipe ends, and in connection to the joint element there is set up, between the sealing systems, a fluid channel system that is formed by, outside respective sealing elements, a radially formed ring-formed hollow space defined between respective, oppositely directed flange surfaces and the ends of the pipe sections where the hollow space is fluid connected with another channel system via the joint element and connected to a pressure sensor that can register the pressure in the fluid channel system.

The preferred embodiments are given in the claims 10-18.

Thus, the present invention relates to the placing of a double barrier in that two or more gaskets are placed against each pipe surface in its contact with the joint piece. Furthermore, a fluid channel system through the joint piece and the ring channel in the contact area between the pipe ends and the joint piece is maintained between the two gasket systems, to be able to detect leakages past these when the pipes are fitted together.

Thereafter, the solution comprises that there a fluid-carrying/gas-carrying groove is arranged between the two gaskets on each side, where the groove is connected with a channel that be closed, such as with a closing screw.

When the bolt (40) is screwed out and loosened one can connect up a pressure pump with a measuring unit. Then one can fill the groove between the gaskets with a fluid (gas or liquid) under pressure and continuously measure the pressure. When one has reached the desired pressure, one holds this pressure constant for a suitable period. When the pressure in the closed system, including the groove, stays constant, the two gaskets are leakproof. If the pressure changes it is an indication that the gaskets leak. Thereby, one can, in a simple way, control the quality of the gasket, i.e. leak and pressure testing the system without coming in contact with the fluid or medium (gas/liquid) under pressure that flows inside the pipe. One can, of course, pressure test a pipe without filling the whole pipe with gas/liquid under pressure to pressure regulate the pipe system. The pressure testing takes place in that a fluid is led into the channel system at a given pressure to measure any changes. These changes are in the form of that air flows in or out through the outer gasket, and possibly correspondingly through the inner gaskets against the pipe fluid.

The advantage of the pressure test gasket is that one saves much time to pressure test pipe racks/flanges. In addition, it can reduce the pollution if pipes must be filled with liquid media/gas that is environmentally harmful.

### FIGURES TO DESCRIBE THE INVENTION

The invention shall be explained in more detail with reference to the following figures, in which:

FIG. 1 shows an overview picture of the present invention where two pipes are joined together end to end with the help of a joint piece.

FIG. 2 shows a longitudinal section through the joint with the inventive construction.

FIG. 3 shows an enlarged section of the construction.

FIG. 4 shows a perspective part section of the inventive construction to show the joint piece which, in a sealing way, combines the two pipes that shall be joined together.

### DETAILED DESCRIPTION OF PREFERRED EMBODIMENTS

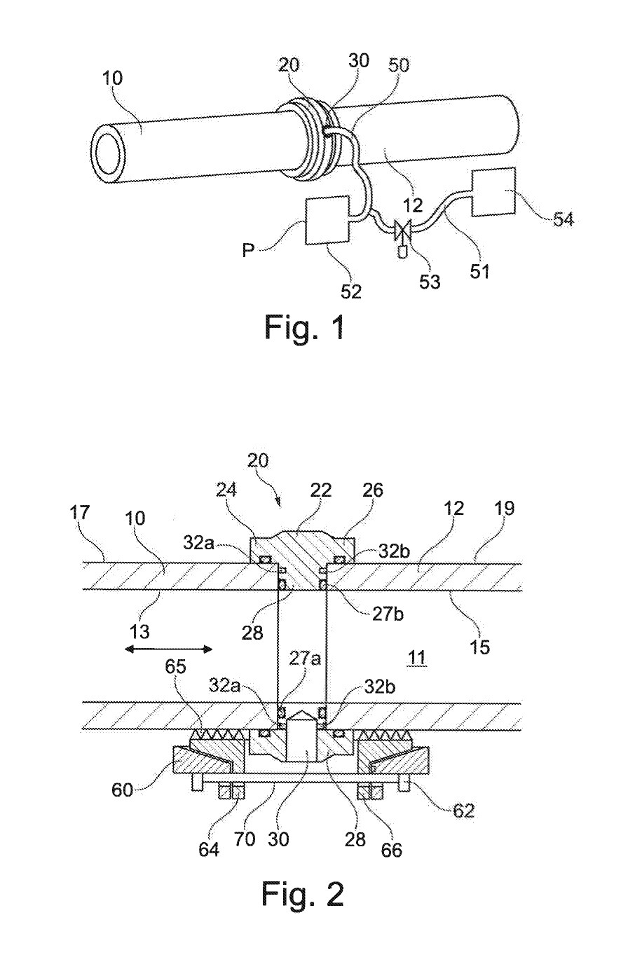

Reference is initially made to FIG. 1 that shows pipes, 10,12 that are coupled together by the use of an intermediate lying joint piece 20. The pipes 10,12 make up a part of the longer stretch of pipes that internally, shown by 11 in FIG. 2, can bring forward a fluid such as gas and/or liquid under a given pressure, and can be used for different purposes. The surfaces of the pipes are shown by 17 and 19, respectively, in FIG. 2.

The joint piece 20 comprises a separate channel system in the form of recessed, ring-formed grooves in the surfaces to form closed channels when the pipe ends are placed against respective flange surfaces, whereupon a fluid or gas is supplied that is held under pressure to show up leakages. When the pipe ends are fitted to the joint piece the channel system is closed and is used to show up leakages over the set of gaskets.

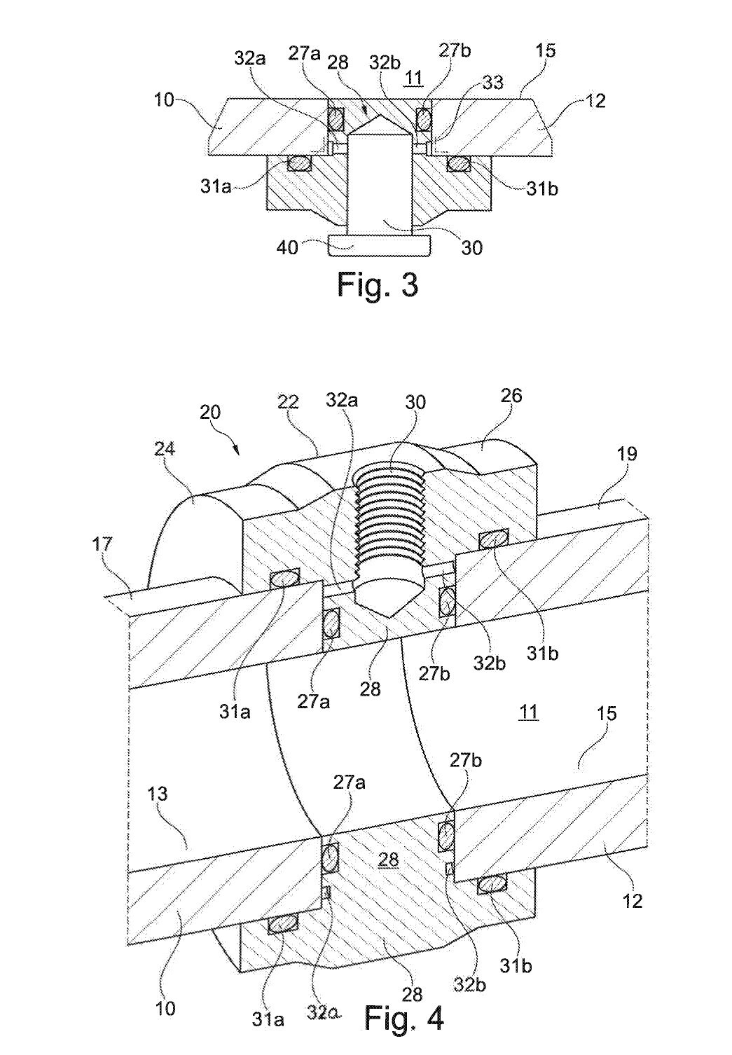

The joint piece 20 is shown in more detail in the FIGS. 3 and 4. The joint piece has the form of a casing with a ring-formed central piece 22 from which ring-formed side flanges 24 and 26, respectively, protrude axially from both sides.

Centrally and radially inwards from the middle piece 22, a solid flange 28 extends in a breadth/length that corresponds to the thickness of the pipes 10,12, so that the axial, internal ring surface of the flange 28 is aligned with the inside 13 and 15, respectively, of the pipes when these are joined by the joint piece 20.

When fitted, the end surfaces of the pipes 10,12 lie against the oppositely directed axial surfaces of the respective middle piece flanges 28. Furthermore, each of said axially directed flange surfaces comprises gasket systems 27a and 27b, respectively, in the form of ring-formed recesses each with an inserted gasket in the form of O-rings (see the FIGS. 2-3-4) that form the seal against the respective pipe ends when these are squeezed against the flange surfaces.

When the two pipes are inserted into the joint piece, a clamping body is fed forward from each pipe, something which is shown schematically in FIG. 2, lower part. This is necessary to hold the joint together. It is preferred to use on each pipe end two mutually adapted wedge-formed clamping bodies, where an inner casing section 64 and 66, respectively, comprises inwardly protruding knobs or sharp grooves 65 that can penetrate into the pipe surface at the pipe end and thus be wedged and locked onto the pipe surface. This can occur when the casing sections 60 and 64, respectively, are led against each other, i.e. the knobs are forced into the pipe surface. The fixing against the pipe surfaces and the squeezing together are carried out in a known way by the tightening of axial bolts 70 that are led through axial holes in the outwardly extending parts of the wedge forms 60,64 and 62,66, respectively, around the circumference.

Furthermore, the inside (radially) of each side flange 24 and 26, respectively, comprise analogue gasket systems 31a and 31b, respectively, in the form of ring-formed cut outs, in which respective sealing rings (O-rings) are inserted that squeeze against their separate pipe surface 17 and 19, respectively, on both sides of the middle piece 22 of the joint piece.

In this way, according to the invention, there is a double barrier formed in the way of two gaskets against each pipe surface, where a fluid channel system is formed between these to register pressure and leaks past the gaskets: One ring gasket 27a-b between each pipe end and flange, and also one or more ring-gaskets 31 a-b between the pipe surface and the underside of the joint piece.

With the invention said second gasket system 31a,31b and a channel system are set up which are used to control whether leaks occur from the inside 11 of the pipe and out through the joint areas between pipe ends and flange surfaces and past the gasket set 27a and 27b, respectively. Inside the joint piece 22 a radially directed boring 30 is formed from its outside and some distance into the metal material in the joint piece 20. The boring 30 is fluid connected with an axially directed cross channel 32a,32b through the solid material, that runs axially, if both opposite ends run out in their separate ring-formed recess or groove 34a,34b, formed in the oppositely directed axial flange surfaces. Each ring groove, including each cross channel end, is freely exposed to the metal material in the end surface of the pipe. Consequently, the grooves are lying adjoining the respective ring-end surfaces of the two pipes. Thus, each groove runs around the whole of the axially directed circumference surface of the flange. Furthermore, it is preferred that the boring 30 is threaded so that it is possible to screw in a closing plug when the pressure testing is completed.

As shown in the figures, each of these recesses/grooves 34 and 34, respectively, are positioned in the flange surface radially outside the adjoining ring gaskets 27a and 27b, respectively, that form the main seal between the joint piece 20 and the pipes 10,12. The pressure from a fluid that is in the continuous fluid channel system 30-32a-32b in the joint piece 20 will therefore be affected and change if there are fluid leaks through one or both of the ring gaskets 27a and 27b, respectively, i.e. if the fluid in the pipe (gas or liquid) manages to leak out past the gasket and into the channel system 32.

According to the invention it is essential that there is a ring channel 34 and 36, respectively, that goes around the whole of the pipe circumference between the two sets of gaskets 27 and 31, respectively. Thus, this ring channel can be on the oppositely directed sides of the flange, for example, close to the sets of gaskets 31 and 27, respectively. Alternatively, the ring channel that is in fluid contact with the cross channels 32a,32b, can have other locations between the gaskets 31/27. Each of these can also be placed in the corner area of the flange 28, where the axially directed pipe end surface goes, in a sharp angle, into the circular outer surface of the pipe, or, in its entirety cut out in a ring form around the circumference of the radially inwardly facing surface on the underside of the flange section 24,26 that lies against the circular outer surface of the pipe.

When one or more of the two types of gasket sets starts to leak, fluid (liquid/gas) will start to trickle out into the small intermediate space that exists between the two meeting metal surfaces and up to said fluid channel system 30-32a-32b. Such flow will always take place from a higher pressure to a lower pressure.

Such leaks will always affect the pressure in the channel system 30-32a-32b. By measuring the pressure in the channel system 30-32a-32b, leaks from the inner of the pipe can be detected in the form of the pressure in the channel system changing. The extent of the joining area in which leaks can be measured is between the two gasket types 27 and 31 and is indicated schematically by the dotted line 33 in FIG. 3.

Furthermore, a pressure change will also occur if there is a leak in the outer set of gasket 31. This side of the fluid channel system ends up and can be measured at the joint interspace space between the set of gaskets 27 and 31, respectively.

Normally, there will be ordinary air in the fluid channel circuit 30,32 and the detection of leaks can consist in that the outlet from the channel is connected to a hose 50 to a pressure sensor P/52 shown schematically in FIG. 1. As the free outlet is then shut, the leaks over the gasket 34 and/or 34, respectively, show up as pressure changes in the fluid channel circuit measured by the pressure sensor via the hose. If the pressure inside the pipe set 10,12 is lower it will be measured as a drop in pressure, while if it is any higher it will be measured as a pressure increase. If no pressure changes are registered over time it means that the set of gaskets functions as intended. If any leaks ought to or must be detected by the use of other types of fluid other than ordinary air that is permanently in the fluid channel system, the hose 50 can also be connected to a fluid reservoir F/54 (for example, an inert gas) with a pump and via a hose 52 that also includes a stop valve 53.

In practice, one can set up one or more continuous pressure measurements in a joint area between two pipe sections in this way. When it does not give the reading indicated above, the boring 30 is plugged again with a bolt that will shut the channel completely. This can be a threaded bolt 40 that is screwed in through the threaded boring as indicated in the figure.

It is assumed that the pressure inside the pipeline is different from the pressure in the fluid channel system so that any leaks over the gasket set 27 lead to a fluid flow and build-up of pressure or pressure drop in the fluid channel system. This means that the pressure can be above or below the atmospheric pressure. In any case, the pressure of the fluid that is inserted into the fluid channel system can be regulated with the help of the pump, i.e. above or below the atmospheric pressure according to what is needed in the various situation.

1. Method to detect a fluid leakage in a joint area between two pipe sections (10, 12) that are joined together to provide a continuous fluid-carrying pipeline, where a casing-formed joint element (20) with an inwardly protruding ring-formed flange part (28) is inserted between the pipe sections (10, 12), the ends of which lie against sealing elements (27a, 27b) at the oppositely directed flange surfaces, and a coupling body (60,62) on each side of the joint element (20) forms an engagement with respective pipe circumference surfaces (17, 19) and is made to squeeze the pipe ends against each other via the joint element (20), characterised in that
a second sealing element (31 a, 31 b) that seals between the joint element (20), and the pipe section surfaces (17, 19) at the pipe ends is arranged, and any fluid leakages that occur past the two sealing systems (27,31) are monitored in a fluid channel system (30,32), set up in connection to the joint element (20) between the sealing systems (27,31), the channel system is formed by a radially formed ring-formed hollow space (32a, 32b), outside respective sealing elements (27a, 27b), defined between respective oppositely directed flange surfaces (28) and the ends of the pipe sections (10, 12) where the hollow space is fluid connected with another channel system (30) via the joint element and connected to a pressure sensor (P,52) that registers the pressure in the fluid channel system for alarms and the initiation of relevant actions.

2. Method according to claim 1, characterised in that the pressure is measured in the ring-formed hollow spaces (32a, 32b), each is defined by a ring-formed recessed groove in each of the oppositely directed flange surfaces (28) that a pipe end lies against.

3. Method according to claim 1 claims 1-2, characterised in that a branched fluid channel system (32,30) is used with respective established part hollow spaces (32a, 32b) in contact with the surface of their respective pipe—on each side of the joint element, as said part hollow space (32a, 32b) runs together into a common channel or boring (30) through the joint element (20) and out to the pressure sensor (P.52).

4. Method according to claim 1 one of the preceding claims, characterised in that a channel system (30,32) is used where each said hollow space (32a,32b) towards the surface (9) of the pipe material is bound and lies between said sealing element (27a, 27b) and there is a second gasket system (31 a,31 b) that seals between the joint element (20) and the pipe surfaces (17, 19).

5. Method according to claim 1 one of the preceding claims, characterised in that when the measuring of the leakage after the fitting of the pipes has been completed, the common boring (30) that is a threaded hole running radially into the joint element is sealed and closed in that a threaded bolt (40) is screwed into the hole.

6. Method according to claim 1 one of the preceding claims, characterised in that a joint piece (20) with a radially inwardly protruding flange section is used with oppositely directed flange surfaces that the respective pipe ends are axially clamped against with in-between lying said sealing rings (27a, 27b), as said two gasket systems in the form of O-rings, one or more on each side, are placed around the pipe circumference and said part hollow spaces (32a, 32b) are formed adjoining the mutually oppositely directed flange surfaces.

7. Method according to claim 1 one of the preceding claims, characterised in that the part hollow spaces (32a, 32b) are formed by recessed ring-formed grooves that are cut out in the respective, axially directed flange surfaces of the joint piece (20).

8. Method according to claim 1 one of the preceding claims, characterised in that each set of gaskets (31) is formed by O-rings that are placed in recesses formed in the underside of the axially directed side flanges (24, and 26, respectively) of the joint piece (20).

9. Method according to claim 1 one of the preceding claims, characterised in that the fluid pressure in the fluid channel system (30,32) is regulated to lie above, below or at the atmospheric pressure according to what is in agreement with the pressure in the fluid that is brought forwards in the pipeline.

10. Device to detect a fluid leakage in a joint area between two pipe sections (10, 12) that are joined together to provide a continuous fluid-carrying pipeline, where a casing-formed joint element (20) with an inwardly protruding, ring-formed flange part (28) is inserted between the pipe sections (10, 12), the ends of which lie against sealing elements (27a, 27b) at the oppositely directed flange surfaces, and a coupling body (60,62) on each side of the joint element (20) forms an engagement with respective pipe-circumference surfaces (17, 19) and squeezes the pipe ends against each other via the joint element (20), characterised in that a second sealing element (31 a, 31 b) that seals between the joint element (20) and the surfaces of the pipe section (17, 19) is arranged at the pipe ends, and in connection to the joint element (20) between the seal systems (27,31) a fluid channel system (30,32) is set up which is formed by a radially formed ring formed hollow space (32a,32b), outside respective seal elements (27a, 27b) and defined between respective, oppositely directed flange surfaces (28) and the ends of the pipe sections (10, 12) where the hollow space is fluid connected to another channel system (30) through the joint element and connected to a pressure sensor (P,52) that can register the pressure in the fluid channel system (30,32).

11. Device according to claim 10, characterised in that each ring-formed hollow space (32a, 32b) is defined by a ring-formed recessed groove with a gasket ring inserted in each of the oppositely directed flange surfaces (28) that a pipe end lies against.

12. Device according to claim 11 claims 10-11, characterised in that a branched fluid channel system (32,30) with respective established part hollow spaces (32a, 32b) in contact with the surface of their separate pipes on each side of the joint, as said part hollow space (32a, 32b) runs together in a common channel or boring (30) through the joint element (20) and out to the pressure sensor (P,52).

13. Device according to claim 10 one of the claims 10-12, characterised in that each said hollow space (32a, 32b) towards the surface (9) of the pipe material is bordered and lies between said sealing element (27a, 27b) and a second gasket system (31 a,31 b) that seals between the joint element (20) and the pipe surfaces.

14. Device according to claim 10 one of the claims 10-13, characterised in that a boring (30) that makes up a part of the fluid channel is a threaded boring that can be sealed by the screwing in of a threaded bolt (40).

15. Device according to claim 10 one of the claims 10-14, characterised in that the joint piece (20) comprises a radially inwardly protruding flange section with oppositely facing flange surfaces that the respective pipe ends are axially squeezed against with in-between lying said sealing rings (27a, 27b), as said two gasket systems in the form of O-rings, one or more on each side, are placed around the pipe circumference, and said part hollow spaces (32a,32b) are arranged adjoining the opposite flange surfaces.

16. Device according to claim 10 one of the claims 10-15, characterised in that the part hollow spaces (32a, 32b) are formed by a recessed ring-formed groove that is cut out in the respective axially directed flange surfaces of the joint piece (20).

17. Device according to claim 10 one of the claims 10-16, characterised in that each set of gaskets (31) is formed by O-rings that are placed in the ring-formed recesses cut out in the underside of the axially outwardly extending side flanges (24 and 26, respectively) of the joint piece (20) and which are squeezed against the pipe surfaces.

18. Device according to claim 10 one of the claims 10-17, characterised in that each ring-formed recess (32a, 32b) between the two seals (27,31) are is formed in the inner corner area of the flange (28) where the axially, oppositely directed pipe end surface “goes over” the circular outer surface of the pipe at a sharp angle, or it is in its entirety cut out in a ring-form around the circumference in the radially, inwardly facing surface on the underside of the flange section (24,26) that lies against the circular outer surface of the pipe (17, 19).
